(19) United States
(12) Patent Application Publication
(10) Pub. No.: US 2002/0167865 A1
(43) Pub. Date: Nov. 14, 2002

(54) Hairspring, hairspring structure and speed control mechanism and timepiece using the same

(76) Inventors: Takeshi Tokoro, Chiba-shi (JP); Koichiro Jujo, Chiba-shi (JP); Morinobu Endo, Suzaka-shi (JP)

Correspondence Address: ADAMS & WILKS, 31st Floor, 50 Broadway, New York, NY, 10004, US

(21) Appl. No.: 10/134,215

(22) Filed: Apr. 26, 2002

(30) Foreign Application Priority Data
May 11, 2001 (JP) 2001-142140

(51) Int. Cl. G04B 17/04

(52) U.S. Cl. 368/175

(57) ABSTRACT

To provide a hairspring main body having small variation in spring property even in an inclined state by enabling to minimize individual difference and difficult to undergo influence of static electricity or external magnetic field, a hairspring structure capable of being easily integrated accurately in a state of restraining individual difference to a minimum, a speed control mechanism having small variation in a property caused by an inclined state or individual difference and a movement using the same. A hairspring structure of a speed control mechanism of a movement includes a hairspring main body made of carbon nanofiber and a hairspring attaching portion made of carbon nanofiber integrally molded with the main body, coupled to one end portion of the main body and substantially rigid.

### BACKGROUND OF THE INVENTION

1. Field of the Invention

The present invention relates to a hairspring, more in details, relates to a hairspring suitable for being used in a speed control mechanism such as a mechanical type movement.

2. Description of the Prior Art

A speed control mechanism 101 of a mechanical type movement is provided with a balance core 140 rotatably supported by upper and lower bearings 111 and 121 around a central axis line C in P1 and P2 directions, a tenwa (balance wheel) 130 attached to a central shaft portion 141 of the balance core 140 by an armportion, that is, an amida portion 131 in a diameter direction, a hairspring holder 150 fixedly mounted to an upper side shaft portion 142 of the balance wheel 140, a hairspring 160 substantially in a spiral shape, an inner peripheral side end portion 161 of which is fitted to an attaching groove 151 of the hairspring holder 150 and which is fixed by calking, and a hairspring stud 170 constituting a portion of an upper structure 110 including the bearing 111 and having an attaching groove 171 fitted with an outer peripheral side end portion 162 of the hairspring 160 to fix by calking. An oscillation seat 180 having an oscillation jewel 181 is fixed to a lower side shaft portion 143 of the balance core 140. The hairspring 160 is provided with a circular arc portion 163 having a constant radius at a vicinity of the outer peripheral side end portion 162 and the circular arc portion 163 is engaged with a regulator 190 a position of which is adjustable in a circumferential direction P. Further, there are formed transit portions 164 and 165 diameters of which are significantly changed, at both end sides of the circular arc portion 163 of the hairspring 160. In this case, a hairspring main body portion 166 indicates a portion functioning as a spiral spring between a portion 167 on an outer peripheral side of a portion of the inner peripheral side end portion 161 of the hairspring 160 calked into the attaching groove 151 of the hairspring holder 150 and substantially integrated to the hairspring holder 150, and a portion 168 on an inner peripheral side of a portion of the outer peripheral side end portion 162 calked into the attaching groove 171 of the hairspring stud 170 and integrated substantially to the hairspring holder 170, and a balance with hairspring 102 indicates a total of the balance core 140, the balance wheel 130 and the oscillation seat 180.

A property of reciprocal rotation or reciprocal pivoting of the balance with hairspring 102 around the central axis line C in P1 and P2 directions, particularly, a period T thereof is typically dependent on moment of inertia of the balance with hairspring 102 around the central axis line C in addition of a property of a spring of the hairspring main body portion 166 and attaching positions thereof at the both ends 167 and 168 and calked states (attitudes at the grooves 151 and 171 and a position of the regulator 190 in P direction, further, when the central axis line C is inclined, a spring property of reciprocal rotation (enlargement and contraction of spiral) in P direction of the hairspring main body portion 166 dependent on the inclined state and moment of inertia of the balance with hairspring 102 and the spring characteristic of the hairspring main body portion 166 in accordance with the inclined state.

Further, conventionally, as the hairspring 160, there is used a ribbon-like wire made of a constant modulus alloy such as coelinvar or elinvar to minimize temperature dependency of the spring characteristic and the alloy wire is curled in a mainspring-like shape, that is, the spiral shape and quenched to thereby form the hairspring 160.

The wire alloy used as the hairspring 160 is provided with a comparatively large mass and therefore, it is difficult to completely disregard that the hairspring 160 is brought into a state of being eccentric to a lower side by its self weight in accordance with a direction of the central axis line C and it is difficult to avoid the spring property of the hairspring main body portion 166 from depending on the direction of the central axis line C.

Whereas the spring property of the hairspring main body portion 166 is dependent on a dimension or a shape of the hairspring main body portion 166, in curling the wire into the mainspring-like shape, that is, the spiral shape, it is difficult to avoid the shape of the hairspring main body portion 166 from causing a dispersion or an individual difference to some degree. Further, in calking to fix the end portions 161 and 162 of the hairspring 160 respectively into the attaching grooves 151 and 171 of the hairspring holder 150 and the hairspring stud 170, not only an integrating step is complicated but also attitudes of fixing the end portions 161 and 162 to the grooves 151 and 171 by calking, are more or less shifted from predetermined attitudes, thereby, there is a concern that the hairspring is made eccentric (deviated horizontally) in view of a plane of FIG. 4A or causes waviness (deviated vertically) in view of a section as shown by FIG. 4B. Such a deviation of the shape of the hairspring main body portion 166, causes a variation depending on a direction of inclination of the rotational axis line C in the spring property of the hairspring main body portion 166. Further, a dispersion in directions (attitudes) of attaching the calked end portions 161 and 162 to the attaching grooves 151 and 171 of the hairspring holder 150 and the hairspring stud 170, causes an individual difference in a speed control mechanism using the hairspring main body portion 166.

In order to resolve the above-described dispersion, it is necessary to adjust a shape (degree of bending) of the hairspring individually. However, in the adjustment, there is needed technical skill of a skilled craftsman and therefore, the production efficiency is poor and also the adjusting fee becomes expensive. Hence, there is requested a hairspring capable of being easily adjusted. Further, the material of the conventional hairspring is substantially a magnetic metal and the hairspring may be stopped by influence of static electricity or external magnetic field or a deviation in a rate thereof may be caused. Hence, it is desired to fabricate a hairspring by a material which is difficult to undergo influence of a magnetic field.

### SUMMARY OF THE INVENTION

The invention has been carried out in view of the above-described various points and it is a first object thereof to provide a hairspring capable of restraining an individual difference to a minimum and having a small variation in a spring property even in an inclined state. It is another object of the invention to provide a hairspring which is difficult to undergo influence of static electricity or external magnetic field.

It is a second object of the invention to provide a hairspring structure capable of being easily integrated accurately in a state of restraining an individual difference to a minimum.

It is a third object of the invention to provide a speed control mechanism having a small dispersion in the property by an inclined state or an individual difference and a timepiece using the speed control mechanism.

In order to achieve the above-described first object, according to the invention, there is provided a hairspring constituted by being integrally molded by using a carbon nanofiber.

Since the hairspring is “made of carbon nanofiber”, a density thereof is smaller than that of the conventional hairspring made of an alloy and therefore, even when a central axis line is inclined, deformation by self weight of the hairspring can be restrained to a minimum. Therefore, a variation in a spring property of a hairspring caused in inclination of the central axis line or a change in an attitude of the hairspring can be restrained to a minimum. Further, since the hairspring is “made of carbon nanofiber”, the hairspring is essentially nonmagnetic and accordingly, there is rarely a concern of undergoing influence of external or surrounding magnetic field. Further, since the hairspring is “integrally molded”, that is, formed by a molding die and integrally and therefore, the shape of the hairspring in a spiral shape can uniformly be prescribed by a fabricating condition such as a molding die and therefore, a dispersion in a spring property by individual difference can be restrained to a minimum. As a result, a necessity of adjustment of adjusting the shape of the hairspring is minimized. In addition, by selecting a condition which is pertinent and is capable of controlling mass production as a fabricating condition by a molding die or the like, a hairspring having a desired property can be fabricated easily and firmly in an ideal shape such as an Archimedean curve or spiral or a shape near thereto.

Further, according to a hairspring made of carbon nanofiber, the elastic constant such as Young's modulus differs from that of the conventional hairspring and therefore, in order to constitute a hairspring having a property similar to that of the conventional example, at least either of a width of the hairspring in a mode of a spiral ribbon (length in an axis line direction of a spiral) and a length (a length along a direction of extending the spiral), typically, the width is changed to a predetermined size, however, when a difference in the density (specific weight) of the hairspring is taken into consideration, the length of the hairspring may be changed to a predetermined size. Naturally, when desired, there may be constituted a hairspring having a reciprocal pivoting (reciprocal rotation) period different from that of the conventional example. Further instead of constituting a shape of a cross-sectional face of a hairspring by a rectangular shape, the shape may be other shape such as an elliptical shape or a circular shape.

In order to achieve the first and the second object, according to the invention, there is provided a hairspring structure comprising a hairspring main body made of a carbon nanofiber, and a hairspring attaching portion made of a carbon nanofiber which is molded integrally with the main body, coupled to one end portion of the main body and substantially rigid.

According to the hairspring structure of the invention, since “a hairspring main body is made of a carbon nanofiber”, operation and effect similar to that in the case of the above-described hairspring is achieved with regard to the hairspring main body. Further, according to the hairspring structure of the invention, since “a hairspring attaching portion made of a carbon nanofiber which is substantially rigid is molded integrally with the hairspring main body and connected to one end portion of the main body”, in integrating the hairspring structure, instead of fixing a front end portion of the hairspring into an attaching groove of the hairspring attaching portion such as a hairspring holder or a hairspring stud, the rigid hairspring attaching portion may be fixed to a supporter thereof and therefore, not only the integration can easily be carried out in comparison with the case of fixing the hair spring which is easy to deform but also in the integration, it is facilitated to fix the hairspring main body to the supporter by an accurate position or a direction (attitude). That is, according to the hairspring structure of the invention, an end portion of the hairspring main body and the hairspring attaching portion connected to the end portion (that is, hairspring holder or hairspring stud) are integrally molded and therefore, the end portion of the hairspring main body and the hairspring attaching portion connected thereto (that is, hairspring holder or hairspring stud) can firmly be formed under a predetermined positional relationship prescribed by a fabricating or a molding condition such as a shape of molding die and therefore, eccentricity in a spiral face of the spiral shape spring portion of the hairspring main body and waviness (positional deviation) in a direction orthogonal to the spiral face in a section orthogonal to the spiral face accompanied by inaccuracy of integrating the hairspring structure, can be restrained to a minimum and dispersion by individual difference can also be restrained to a minimum. Further, it is not necessary to attach the front end portion of the hairspring to the hairspring attaching portion and therefore, a concern of causing unexpected deformation to the main body by erroneously exerting unexpected force to the hairspring main body in the attaching operation, can also be restrained to a minimum. In this case, the hairspring attaching portion is typically either of a hairspring holder or a hairspring stud. However, when desired, the hairspring attaching portion may be both of the hairspring holder and the hairspring stud.

Further, when the hairspring holder or the hairspring stud is integrally molded with the hairspring (main body), instead of a conventional structure or shape taking into consideration that the hairspring holder or the hairspring stud is fixed to a related end portion of the hairspring (that is, inner peripheral side end portion or outer peripheral side end portion), there may be constituted a structure or a shape suitable for integral molding, there may be constituted a structure or a shape suitable for fixing the hairspring holder made of carbon nanofiber to a balance core or there may be constituted a structure or a shape suitable for fixing the hairspring stud made of carbon nanofiber to other member.

Similarly, the end portion of the inner peripheral side or the outer peripheral side of the hairspring main body integrated to the hairspring holder or the hairspring stud may be constituted such that in order to avoid excessive stress concentration from being caused at the end portion, for example, the end portion is comparatively thick at an integrally coupled front end and the farther the end portion from the front end along the hairspring main body, the slenderer the end portion becomes gradually and the end portion is provided with a constant thickness or a sectional shape only after being disposed at a location remote from the end edge to some degree.

Further, when the hairspring main body is integrally molded with the hairspring holder, the balance core may simultaneously be molded integrally therewith by carbon nanofiber. In that case, owing to low frictional performance of carbon nanofiber, support of reciprocal pivoting of the balance core by a receiving jewel or a bearing is carried out at low friction. Further, in this case, a flange or a flange portion for supporting an arm portion or an amida portion in a radius direction of a balance wheel is typically formed integrally not with the balance core portion but with an oscillation seat.

In this specification, “made of carbon nanofiber” with regard to “hairspring” or “hairspring main body” or the like, signifies to include carbon nanofiber as a major component such that a property of carbon nanofiber having a small specific weight is made full use and a stable spring performance without creep can be achieved. A rate of carbon nanofiber is preferably about 1 weight % through about 60 weight %. Further, a coupling member or a binder for mutually coupling carbon nanofibers in order to integrally form a hairspring or a hairspring structure, may be a resin or the like, may include a resin or the like, may be a constitution actually carbonated by baking a resin or the like or may be constituted by other member so far as the coupling member or the binder falls in a range of capable of substantially avoiding a creep phenomenon or composition flow in a binder material at a spring portion.

An integrally molded hairspring or hairspring structure made of carbon nanofiber may be formed such that powder or a very small needle-like body of carbon nanofiber is mixed with, for example, thermoplastic plastic, molded by injection molding, powder molding or the like, baked further and substantially sintered while carbonating the plastic material, or mixed with a material of thermosetting plastic, molded by compression molding, transfer molding or the like, baked further and substantially sintered by carbonating the plastic material.

Although carbon fiber used for molding typically comprises so-to-speak single layer carbon nanotube, the carbon nanofiber may be constituted by plural layers (multiple layers) or may be mixed with single layers thereof and plural layers thereof. In the case of multiple layers, two or three layers may be laminated, more than two or three layers, for example, several tens layers maybe laminated, depending on cases, several hundreds layers or more may be laminated. Further, the carbon nanofiber may be constructed by a constitution having a constant diameter, chiral angle or spiral pitch or may be constructed by a constitution mixed with different diameters or chiral angles. A diameter or the like of a respective carbon nanofiber per se may not be constant. Further, although carbon nanofiber typically comprises only carbon, depending on cases, small particles of carbon of other kind (small particles in the form of graphite, small particles in the form of amorphous carbon, small particles in the form of carbon black or the like) or other kind of atoms, molecules or small particles or the like may be adhered to the surface of the nanofiber or may be mixed with nanofiber particles.

Carbon nanofiber typically comprises powder or small particles to be easy to disperse uniformly into a comparatively small amount of a resin material or the like for constituting a binder in molding and a diameter thereof falls in a range of about 1 nm (nanometer) through about several tens nm, a length thereof falls in a range of about several nm through several thousands nm and an aspect ratio thereof is equal to or more than 50.

In molding by using a resin material, in order to minimize a change in a dimension or a shape by carbonating and sintering after molding the resin, it is preferable that a rate of molding material of the resin material or the like is comparatively small. When the small particle of the carbon nanofiber is small and a molding material including the resin material and a molding assisting agent added as necessary, can be provided with sufficient fluidity, there is used injection molding utilizing thermoplastic resin, compression molding or transfer molding utilizing a thermosetting resin material. In this case, although a rate of the small particle of carbon nanofiber is preferably equal to or more than, for example, about 50 volume %, depending on cases, the rate may be smaller, for example, may be about 20 through 30 volume %. Meanwhile, when the rate of carbon nanofiber is increased, in the form of powder, powder molding may be carried out along with a small amount of a binder.

Carbonating and baking (typically sintering) after molding a resin is typically carried out after removing the resin from a molding die. However, when desired, after molding, in a molding die, the resin may further be carbonated or carbonated and baked. Further, a degree of carbonating or sintering may pertinently be selected in accordance with spring performance to be provided to a hairspring or a hairspring structure, or depending on cases, low friction performance desired in a balance core. For example, in carbonating, the resin may partially remain so far as plastic fluidity particular to the resin can be avoided from being caused at a portion for constituting a spring portion and when the resin can partially operate as a binder between carbon nanofibers, a degree of sintering by baking may be restrained to be low. Temperature, time period and an atmospheric condition of sintering by carbonating or baking may pertinently be changed in accordance with a kind or a rate of a resin material.

Further, although according to the above-described, an explanation has been given such that a total of a hairspring or a hairspring structure is formed by one kind of a blending material and under the same carbonating and baking condition, the hairspring or the hairspring structure may be formed by materials having different blending rates in accordance with a portion of the hairspring, a hairspring main body and a hairspring attaching portion (hairspring holder or hairspring stud) of a hairspring structure maybe formed by materials having different blending rates, a hairspring may be carbonated or baked (sintered) at different temperatures in accordance with portions thereof, the hairspring attaching portion (hairspring holder or hairspring stud) may be carbonated or baked (sintered) at different temperatures in accordance with portions thereof (in the former case, for example, hairspring holder portion and balance core portion), or the hairspring main body and the hairspring attaching portion of the hairspring structure may be carbonated or baked (sintered) at different temperatures.

The above-described hairspring or the hairspring structure is suitable for forming a speed control mechanism having small dispersion in the property caused by an inclined state or individual difference by combining with a balance wheel or the like and particularly suitable of being used in a movement or the like requested to be thin, small or light.

### BRIEF DESCRIPTION OF THE SEVERAL VIEWS OF THE DRAWINGS

A preferred form of the present invention is illustrated in the accompanying drawings in which:

FIG. 1 illustrate views explaining a movement having a speed control mechanism having a hairspring structure according to a preferable first embodiment of the invention in which FIG. 1A is an explanatory plane view in which a portion of the speed control mechanism is notched, FIG. 1B is an explanatory sectional view taken along a line IB-IB of FIG. 1A (however, only an amide portion of a balance wheel is shown in a state of being disposed at a position rotated by 90 degrees to understand a total in a longitudinal direction thereof), FIG. 1C is an explanatory view of a modified example of integrally molded connection of a hairspring stud and a hairspring main body portion, FIG. 1D is an explanatory view of other modified example of integrally molded connection between a hairspring stud and a hairspring main body portion and FIG. 1E is an explanatory view of still other modified example of integrally molded connection of a hairspring stud and a hairspring main body portion;

FIG. 2 illustrate views for explaining a movement having a speed control mechanism having a hairspring structure according to a preferable second embodiment of the invention in which FIG. 2A is an explanatory partially notched plane view similar to FIG. 1A with regard to the speed control mechanism, FIG. 2B is an explanatory sectional view taken along a line IIB-IIB of FIG. 2A (however, similar to FIG. 1B, only an amida portion of a balance wheel is shown in a state of being disposed at a position rotated by, 90 degrees) and FIG. 2C is an explanatory view of a modified example of integrally molded connection between a hairspring holder and a hairspring main body portion;

FIG. 3 illustrate views for explaining a movement having a speed control mechanism having a hairspring structure according to a preferable third embodiment of the invention in which FIG. 3A is an explanatory partially notched plane view similar to FIG. 1A with regard to the speed control mechanism and FIG. 3B is an explanatory sectional view taken along a line IIIB-IIIB of FIG. 3A (however, similar to FIG. 1B, only an amida portion of a balance wheel is shown in a state of being disposed at a position rotated by 90 degrees); and

FIG. 4 illustrate views for explaining a conventional mechanical type movement having a speed control mechanism having a hairspring in which FIG. 4A is an explanatory partially notched plane view with regard to the speed control mechanism and FIG. 4B is an explanatory sectional view taken along a line IVB-IVB of FIG. 4A (however, only an amida portion of a balance wheel is shown in the state of being disposed at a position rotated by 90 degrees).

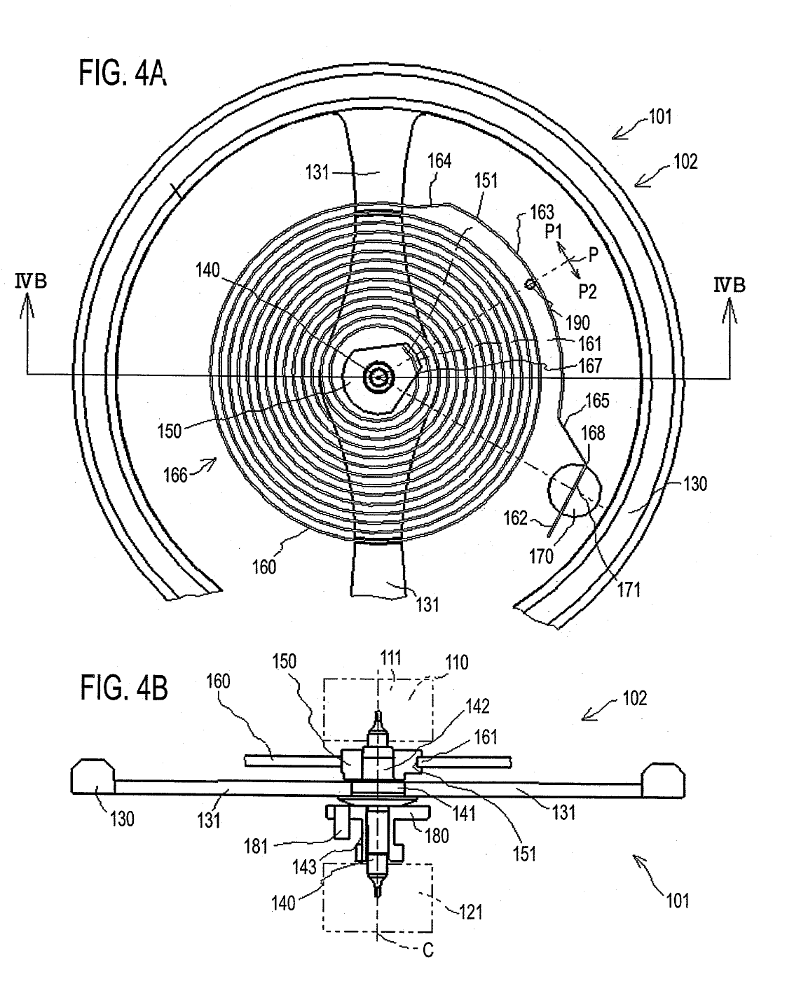

### DETAILED DESCRIPTION OF THE PREFERRED EMBODIMENTS

Next, an explanation will be given of a preferable mode for carrying out the invention based on preferable embodiments.

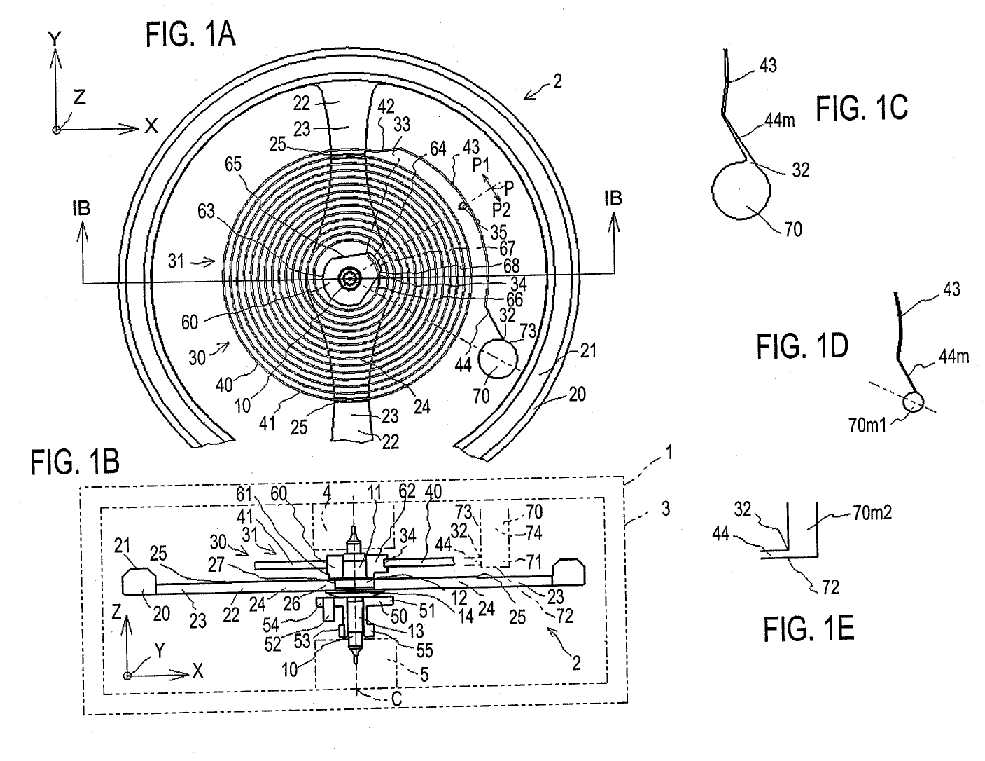

FIG. 1 show a speed control mechanism 2 of a movement 1 according to a preferable first embodiment of the invention. The speed control mechanism 2 is provided with a balance core 10, a balance wheel 20, a hairspring structure 30 and an oscillation seat 50. Further, numeral 60 designates a hairspring holder. In the following, for convenience of explanation, there is adopted a three-dimensional orthogonal coordinates system X, Y, Z defining X-Y plane by a face of FIG. 1A and defining Z direction by an upper direction in FIG. 1B.

The balance core 10 is typically supported rotatably around an axis line C by upper side and lower side receiving jewels or bearings 4 and 5 attached to a supporter 3 such as a main plate stationarily mounted to a case of the movement 1. Further, in the specification, in FIG. 1B, +Z direction and −Z direction are referred to as “upper direction” and “lower direction” for convenience of explanation and naturally, a direction of the speed control mechanism 2 of the movement 1 is varied in accordance with a direction of the wrist or the like attached with the movement 1. The balance core 10 is made of, for example, brass and is provided with an upper side shaft portion 11 attached with the hairspring structure 30, a central shaft portion 12 attached with the balance wheel 20 and a lower side shaft portion 13 attached with the oscillation seat 50 and a flange or flange portion 14 for supporting the balance wheel 20 is formed between the central axis portion 12 and the lower side shaft portion 13. A structure and a shape of the balance core 10 may typically be similar to those of the conventional constitution.

The balance wheel 20 is made of, for example, brass and is provided with a rim portion 21 in an annular shape or a ring-like shape and an arm portion or an amida portion 22 extended along a diameter of a circle of the rim portion 21 on an inner side of the rim portion 21. According to the illustrated example, the amida portion 22 is slightly thinned at an outer side portion 23 in the radius direction and a stepped portion 25 is formed between the outer side portion 23 and an inner side portion 24. Further, the balance wheel 20 is fixed to the balance core 10 by mounting a central portion 26 having a wide width of the inner side portion 24 in the radius direction of the amida portion 22 at the flange portion 14 and attachedly fitting the central portion 26 to the central shaft portion 12 of the balance core 10 by an opening or a hole 27 at the central portion 26 of the inner side portion 24. A structure and a shape of the balance wheel 20 may also be similar to those of the conventional constitution typically and may actually be any other structure or shape so far as predetermined moment of inertia can be given without hampering movement of the hairspring structure 30 and irrespective of a direction or an attitude of the speed control mechanism 2.

The oscillation seat 50 is provided with an oscillation seat main body 51 made of, for example, brass and an oscillation jewel 52 and the oscillation seat main body portion 51 is provided with a cylindrical portion 53 attachedly fitted to the lower side shaft portion 13 of the balance core 10, a large flange portion 54 disposed on an upper end side of the cylindrical portion 53 and attached with the oscillation jewel and a small flange portion 55 on a lower end side of the cylindrical portion 53. The oscillation jewel 52 of the oscillation seat 50 of the speed control mechanism 2 is engageable with a pallet fork, not illustrated, for adjusting or regulating rotational speed of an escape wheel & pinion (not illustrated) via the pallet fork. A structure and a shape of the oscillation seat 50 may also be similar to those of the conventional constitution typically and may be any other structure and shape so far as the oscillation seat 50 can achieve predetermined link function between a hairspring main body portion 40 of the hairspring structure 30 and the pallet fork (not illustrated) in cooperation with the balance core 10 and the balance wheel 20.

The hairspring holder 60 is made of, for example, brass and is constituted by a lower side ring-like portion 61 having a small diameter and a hairspring holder main body 62 projected from the annular portion 61 outwardly in the radius direction for attaching the hairspring structure 30 and the hairspring holder main body portion 62 is provided with a long partially cylindrical peripheral face 63 having a small diameter, a short partially cylindrical peripheral face 64 having a large diameter and two plane portions 65 and 66 connecting these. At a vicinity of the small diameter peripheral face portion 64 of the main body portion 62 of the hairspring holder 60, there is formed a groove 67 in a circular arc shape extended in a peripheral direction substantially along the peripheral face portion 64 and mounted with the hairspring structure 30 and an outer side peripheral wall 68 of the groove 67 is calked when the hairspring structure 30 is attached.

Although according to the example shown by FIG. 1A and FIG. 1B, the hairspring holder 60 is provided with a structure and a shape similar to those of the conventional constitution, when desired, the structure and the shape of the hairspring holder 60 can be replaced by other arbitrary structure and shape suitable for firmly holding and fixing an inner peripheral end of the hairspring structure 30 which is made of carbon nanofiber and is comparatively hard.

The hairspring structure 30 is provided with a hairspring portion 31 made of carbon nanofiber and in a spiral shape and a hairspring stud portion 70 made of carbon nanofiber integrally molded with the hairspring portion 31. Although compositions of the hairspring portion 31 and the hairspring stud portion 70 are substantially the same typically, depending on cases, the compositions may differ from each other so far as the hairspring portion 31 and the hairspring stud portion 70 can be integrated by integral molding.

The hairspring stud portion 70 is constituted by, for example, a cylindrical shape and according to the example of FIG. 1B, the hairspring stud portion 70 is integrated to an end portion 32 of the hairspring portion 31 at a peripheral face 73 thereof at a vicinity of a lower end 72 of a lower portion 71 and continuously connected thereto in view of a material thereof. When the hairspring stud portion 70 is integrated to the movement 1 as a portion of the speed control mechanism 2 an upper portion 74 in a cylindrical shape is fitted and fixed to a hole portion or a recessed portion (not illustrated) having substantially a complimentary shape of the supporter 3 such as the main plate. In this case, the hairspring stud portion 70 is fixed such that, for example, there is formed a groove such as a V-groove extended in a longitudinal direction at a peripheral face of the upper portion 74 of the hairspring stud portion 70, the upper portion 74 of the hairspring stud portion 70 is fitted to a hairspring holder attaching hole formed at the supporter 3 and a male screw is fastened to a screw hole of the supporter 3 constituting the hairspring holder attaching hole having an opened front end and a front end of the male screw is pressed to the groove of the hairspring stud portion 70. However, in place thereof, the hairspring stud portion 70 may be fixed by, for example, adhering by an adhering agent or by calking to deform a peripheral wall of a recessed portion (not illustrated) of the supporter 3 to a side of the hairspring stud portion 70 or, when desired, by using other fixing means. Further, although the upper portion 74 is typically constituted by the cylindrical shape, for example, there may be constructed a constitution in which a side portion of the cylinder is formed in a planar shape and a planar peripheral face portion engaged with the planar peripheral face portion, is formed at an engaged recessed portion of the supporter 3 to thereby assist fixing by calking or the like.

The hairspring portion 31 is provided with a spiral or a mainspring-like shape substantially similar to that of the conventional constitution in view of a plane view of FIG. 1A except that the hairspring portion 31 is integrated to the peripheral face 73 of the hairspring stud portion 70 at the outer peripheral side end portion 32. That is, the hairspring portion 31 is fixed to the hairspring holder 31 by calking a peripheral wall portion 68 in a state in which an inner peripheral side front end portion 33 thereof is engaged with the groove 67 of the hairspring holder 60. In a mounted state, the hairspring portion 31 forms the hairspring main body portion 40 extended in a spiral shape between an inner peripheral side end portion 34 of the inner peripheral side front end portion 33 intersecting with the planar peripheral face 66 of the hairspring holder 60 and the outer peripheral side end portion side 32 connected to the peripheral face of the hairspring stud 70.

A planar shape of the hairspring main body portion 40, that is, a shape thereof in view of the plane view of FIG. 1A, may typically be substantially the same as a planar shape of the conventional hairspring and is provided with a spiral shape portion 41 having a shape of an Archimedean curve (spiral) or near thereto, an oblique portion or a transition portion 42 on an inner side (inner peripheral side), a circular arc portion 43 and an oblique portion or a transition portion 44 on an outer side (outer peripheral side). That is, the spiral shape portion 41 is fixed to the hairspring holder 60 at the inner peripheral side end portion 34, an outer peripheral side end portion thereof is continuously connected to an inner peripheral side end portion of the inner peripheral side of the oblique portion 42, the inner peripheral side oblique portion 42 is continuously connected to an inner peripheral side end portion of the circular arc portion 43 at an outer peripheral side end portion thereof and the circular arc portion 43 is continuously connected to an inner peripheral side end portion of the outer peripheral side oblique portion 44 at an outer peripheral side end portion thereof. An outer peripheral side end portion of the outer peripheral side oblique portion 44 coincides with the outer peripheral side end portion 32 of the hairspring main body portion 40 and coincides with the outer peripheral side end portion 32 of the hairspring portion 31. The circular arc portion 43 of the hairspring main body portion 40 is brought into contact with a regular 35 supported by the supporter 3 such that a position thereof can be adjusted in peripheral directions P1 and P2, when the regulator 35 is moved in P1 direction, an effective length of the hairspring main body portion 40 is shortened and a reciprocal pivoting period in P1 and P2 directions of the balance wheel comprising the balance wheel 20, the balance core 10 and the oscillation seat 50, is shortened.

The hairspring main body portion 40 is typically provided with a rectangular cross-sectional face shape which stays to be substantially the same over a total length thereof between the inner peripheral side and the outer peripheral side end portions 34 and 32. A thickness along a diameter direction of a spiral in the rectangular section of the hairspring main body portion 40 (thickness in view of X-Y plane) is, for example, about 0.03 mm and a width thereof along a direction in parallel with the axis line C (length in Z direction) is, for example, about 0.1 mm. However, the thickness may be about 0.01 mm or thinner or about 0.05 mm or thinner, further, and the width may be about 0.05 mm or narrower or about 0.03 mm or wider, further, the thickness and the width may be larger or smaller by one digit or more. Typically, the width (length in Z direction) of the hairspring main body portion 40 is selected to a size for canceling a change in a basic spring property (for example, spring constant) by changing the hairspring structure 30 from the hairspring structure 30 made of a conventional alloy to the hairspring structure 30 made of carbon nanofiber. In this case, in place of the width, the thickness may be set to a value in accordance with the property, further, both of the width and the thickness may be changed in accordance with a property to be provided such that the cross-sectional face is provided with a desired aspect ratio (width/thickness) or more in order to minimize occurrence of twist or the like around an axis line in a direction of extending the hairspring main body portion 40. Further, when desired, the basic spring property per se may be changed, further, in place of the rectangular shape, the cross-sectional shape of the hairspring main body portion 40 may be other arbitrary shape such as an elliptical shape.

The above-described hairspring structure 30 is produced, for example, by carrying out injection molding by using a composite resin material dispersed with the carbon nanofiber at a high concentration, carbonating the resin by subjecting a molded product to a heat treatment in a nonoxidizing atmosphere and baking further the carbonated portion to sinter at least partially. Further, for example, even when a binder between carbon nanofibers is substantially carbonated at the hairspring portion 31, at the hairspring stud portion 70, except a vicinity of the end portion 32, a portion or substantially a total of the resin constituting the binder may remain without being carbonated.

Further, the more proximate the transition portion or the oblique portion 44 on the outer peripheral side of the hairspring main body portion 40, the thicker the transition portion or the oblique portion 44 may be as shown by an oblique portion 44m shown by FIG. 1C by exaggeration instead of the constant cross-sectional face in order to avoid stress from concentrating to the end portion 32 for connecting to the hairspring stud portion 70. Also in the case of the oblique portion 44 of FIG. 1A, it is similarly preferable that surfaces or main faces on both sides of the oblique portion 44m are typically bent smoothly to connect to the peripheral face of the hairspring stud portion 70 at the connected end portion 32. Further, according to the hairspring structure 30, since the hairspring portion 31 is integrated with the hairspring stud portion 70, it is not necessary to provide a structure of fixing the hairspring portion 31 such as a groove at the hairspring stud portion 70 and therefore, the hairspring stud portion 70 per se may substantially be rigid in comparison with the hairspring portion 31 and may be fixable to the supporter 3 and as shown by FIG. 1D, a position of a hairspring stud portion 70m1 having a small diameter is set to be the same as that in the case of FIG. 1A.

Further, instead of disposing the lower face 71 of the hairspring stud portion 70 at a position lower than a lower side face of the spiral of the hairspring portion 40 as shown by FIG. 1B, as shown by FIG. 1E, a hairspring stud portion 70m2 may be formed by a length by which lower faces of the both coincide with each other. In this case, as a molding die for injection molding, a recessed portion for molding can substantially be formed only at either of an upper die and a lower die (typically, lower die).

According to the speed control mechanism 2, since the hairspring main body portion 40 is made of carbon nanofiber, a density thereof is smaller than that of the conventional hairspring made of an alloy and therefore, even when the center axis line C is inclined, deformation by self weight of the hairspring main body portion 40 can be restrained to a minimum. Therefore, a variation of a spring property (variation in reciprocal pivoting period or the like) of the hairspring main body portion 40 caused by the change in inclination of the central axis line C of the speed control mechanism 2 of the movement 1 or by a change in attitude of the hairspring main body portion 40, can be restrained to a minimum. Further, the hairspring structure 30 is made of carbon nanofiber and therefore, the hairspring structure 30 is essentially nonmagnetic and therefore, there is rarely a concern of undergoing influence of a magnetic field. Further, the hairspring main body portion 40 is formed by molding by a molding die and therefore, the shape of the hairspring main body portion 40 in the spiral shape can uniformly be prescribed by a fabricating condition such as a molding die or the like and therefore, a dispersion in the spring property by individual difference can be restrained to a minimum. As a result, a necessity of adjustment of the hairspring main body portion 40 can be restrained to a minimum. In addition, by selecting a condition which is pertinent as a fabricating condition by a molding die or the like and by which mass production can be controlled, there can easily and firmly be fabricated the hairspring portion 31 having the hairspring main body portion 40 having a shape of an ideal shape such as an Archimedean curve or a spiral line or near thereto and a desired property.

In addition, according to the hairspring structure 30, the hairspring stud portion 70 constituting the hairspring attaching portion made of substantially rigid carbon nanofiber, is integrally molded with the hairspring main body portion 40 and bonded to the end portion 32 of the main body portion 40 and therefore, in integrating the hairspring structure 30, instead of fixing a front end portion on an outer peripheral side of the conventional hairspring easy to deform in the attaching groove of the hairspring stud by calking, the substantially rigid hairspring stud portion 70 may be fixed to the supporter 3 such as the main plate and therefore, not only the integrating operation is easily carried out in comparison with the case of fixing the hairspring easy to deform but also in the integrating operation, it is facilitated to fix the hairspring main body portion 40 to the supporter 3 by an accurate position or direction (attitude). That is, according to the hairspring structure 30, the outer peripheral side end portion 32 of the hairspring main body portion 40 and the hairspring stud portion 70 connected thereto are integrally molded and therefore, the outer peripheral side end portion 32 of the hairspring main body portion 40 and the hairspring stud portion 70 connected thereto can uniformly be formed under a predetermined positional relationship prescribed by a fabricating or molding condition such as a shape of a molding die and therefore, eccentricity (deviation in X-Y plane) of the hairspring main body portion 40 relative to the center C of the spiral shape spring portion 41 or waviness thereof in a direction orthogonal to the spiral face (+Z or −Z direction) accompanied by inaccuracy in integrating the hairspring structure 30, can be restrained to a minimum, a variation in a spring performance (reciprocal pivoting period or the like) can be restrained to a minimum and a variation by individual difference can be restrained to a minimum. Further, it is not necessary to attach the front end portion on the outer peripheral side of the hairspring to the hairspring stud as in the conventional example and therefore, a concern of causing unexpected deformation at the main body portion 40 by erroneously exerting unexpected force to the hairspring main body portion 40 in attaching, can be restrained to a minimum.

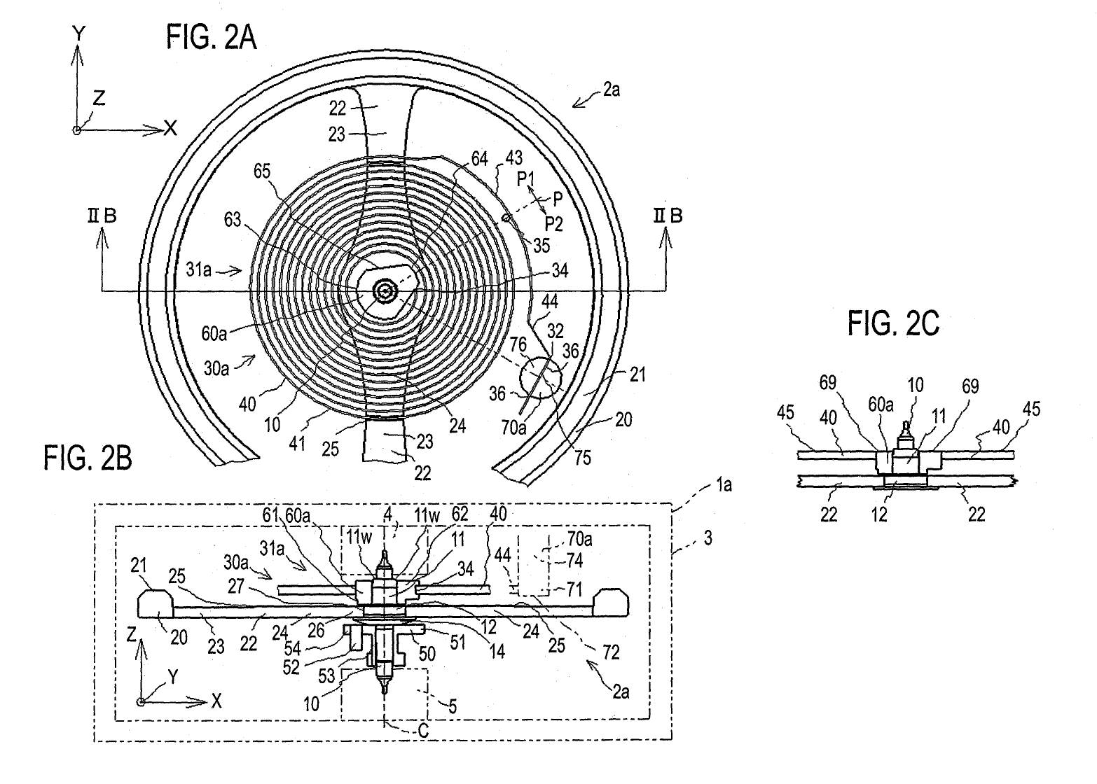

The hairspring main body portion 40 may be integrated to other hairspring attaching portion at the inner peripheral side end portion 34 instead of being integrated to the hairspring attaching portion 3 at the outer peripheral side end portion 32. According to a hairspring structure 30a of a second embodiment shown in FIG. 2, a hairspring holder 60a disposed at the inner peripheral side end portion of the hairspring main body portion 40, is integrated to the hairspring main body portion 40 instead of integrating a hairspring stud disposed at the outer peripheral side end portion to the hairspring main body portion 40. In the second embodiment shown by FIG. 2, members, portions or elements substantially the same as members, portions or elements shown in the first embodiment of FIG. 1, attached with notations the same as those in the case of the first embodiment and members, portions or elements corresponding to but changed from members, portions or elements shown in the first embodiment, are attached with “a” at final portions of notations in a range necessary for explanation.

According to a speed control mechanism 2a of a movement 1a of the second embodiment, the hairspring structure 30a is provided with a hairspring portion 31a made of carbon nanofiber and in a spiral shape and the hairspring holder portion 60a made of carbon nanofiber integrally molded with the hairspring portion 31a. That is, the inner peripheral side end portion 34 of the hairspring portion 31a is integrally connected to the hairspring holder portion 60a at a peripheral face 66 of the hairspring holder portion 60a in view of a material thereof. Although compositions of the hairspring portion 31a and the hairspring holder portion 60a are substantially the same typically, depending on cases, the compositions may differ from each other so far as the hairspring portion 31a and the hairspring holder portion 60a can be integrated by integral molding. The hairspring holder portion 60a is fixed to the balance core 10 by fittedly mounting the hairspring holder portion 60a to the upper side shaft portion 11 of the balance core 10 and thereafter, for example, calking a contiguous bent face portion 11w of the upper side shaft portion 11.

Further, also in the case of the example, as shown by FIG. 2C, in order to simplify a molding die, an upper side edge (side face on +Z side) 45 of the hairspring main body portion 40 may be made to be flush with an upper end face 69 of the hairspring holder portion 60a. Further, similar to the case of FIG. 1C, there may be constructed a constitution in which the more proximate the spiral shape spring portion 41 of the hairspring main body portion 40 to the end portion 34 at a vicinity of the inner peripheral side end portion 34, the more increased is the thickness and the main faces on the both sides are smoothly bent and connected to the face 66 of the hairspring holder portion 60a.

Meanwhile, a hairspring stud 70a is formed by brass or the like separately from the hairspring structure 30a and is provided with a groove portion 75 for fixing the hairspring portion 31a on an inner side of a peripheral wall portion 76. That is, the hairspring portion 31a is provided with the hairspring main body portion 40 substantially in the spiral shape from the inner peripheral side end portion 34 to the outer peripheral side end portion 32 and an outer peripheral side front end portion 36 integrally extended further from the outer peripheral side end portion 32 of the main body portion 40 and the front end portion 36 is fixed to the hairspring stud 70 by fitting the front end portion 36 to the groove portion 75 of the hairspring stud 70a and thereafter calking the peripheral wall portion 76.

It is apparent that even in the speed control mechanism 2a having the hairspring structure 30a as described above, there is achieved operation and effect similar to that of the speed control mechanism 2 shown in FIG. 1. That is, also in the hairspring structure 30a of the second embodiment, the hairspring holder portion 60a constituting a hairspring attaching portion substantially rigid and made of carbon nanofiber, is integrally molded with the hairspring main body portion 40 and bonded to the end portion 34 of the main body portion 40 and therefore, in integrating the hairspring structure 30a, instead of fixing the inner peripheral side end portion of the hairspring which is easy to deform as in the conventional example, into the attaching groove of the hairspring holder by calking, the substantially rigid hairspring holder portion 60a may be fittedly mounted and fixed to the balance core 10 and therefore, not only integration is easily carried out in comparison with the case of fixing the hairspring easy to deform but also in the integrating operation, it is facilitated to fix the hairspring main body portion 40 to the balance core 10. by an accurate position or direction (attitude). Therefore, according to the hairspring structure 30a, the inner peripheral side end portion 34 of the hairspring main body portion 40 and the hairspring holder portion 60a connected thereto, are integrally molded and therefore, the inner peripheral side end portion 34 of the hairspring main body portion 40 and the hairspring holder portion 60a connected thereto, can uniformly be formed under a predetermined positional relationship prescribed by a fabricating or molding condition such as a shape of a molding die. As a result, eccentricity (deviation in X-Y plane) relative to the center C of the spiral shape spring portion 41 of the hairspring main body portion 40 or waviness in the direction orthogonal to the spiral face (+ or −Z direction) accompanied by inaccuracy of integrating the hairspring structure 30a, can be restrained directly and to a minimum and a dispersion by individual difference can be restrained to a minimum.

Incidentally, the shape and the attitude of the spiral shape spring portion 41 of the hairspring main body portion 40, that is, the eccentricity in X-Y plane and the waviness in Z direction can be avoided more effectively in the case of the hairspring structure 30a of the speed control mechanism 2a according to the second embodiment than in the case of the hairspring structure 30 of the speed control mechanism 2 according to the first embodiment.

That is, whereas in the case of the hairspring stud portion 70 of the hairspring structure 30 according to the first embodiment, the hairspring stud portion 70 is connected to the spiral shape spring portion 41 of the hairspring main body portion 40 via the circular arc portion 43 in contact with the regulator 35, the hairspring holder portion 60a of the hairspring structure 30a according to the second embodiment is directly connected to the spiral shape spring portion 41 of the hairspring main body portion 40 at the end portion 34. As a result, an influence of a deviation in a relative positional relationship between the hairspring holder portion 60a and the inner peripheral side end portion 32 of the hairspring main body portion 40, effected on a natural shape (position and shape in a state of not being exerted with external force) of the spiral shape spring portion 41 of the hairspring main body portion 40, in other words, an influence of the hairspring structure 30a effected on a vibration characteristic as the spring, becomes far larger than an influence of a deviation in a relative positional relationship between the hairspring holder portion 70 and the hairspring main body portion 40 effected on a natural shape of the spiral shape spring portion 41 of the hairspring main body portion 40, that is, an influence of the hairspring structure 30a effected on a vibration characteristic as the spring. Therefore, in the hairspring structure 30a, since the deviation in the relative positional relationship between the hairspring holder 60a and the hairspring main body portion 40, can be avoided, the eccentricity (deviation in X-Y plane) of the spiral shape spring portion 41 of the hairspring main body portion 40 can be restrained (a dispersion in a central position can be restrained) and the waviness in the direction (+ or −Z direction) orthogonal to the spiral face can be restrained more effectively than in the case of the example of FIG. 1.

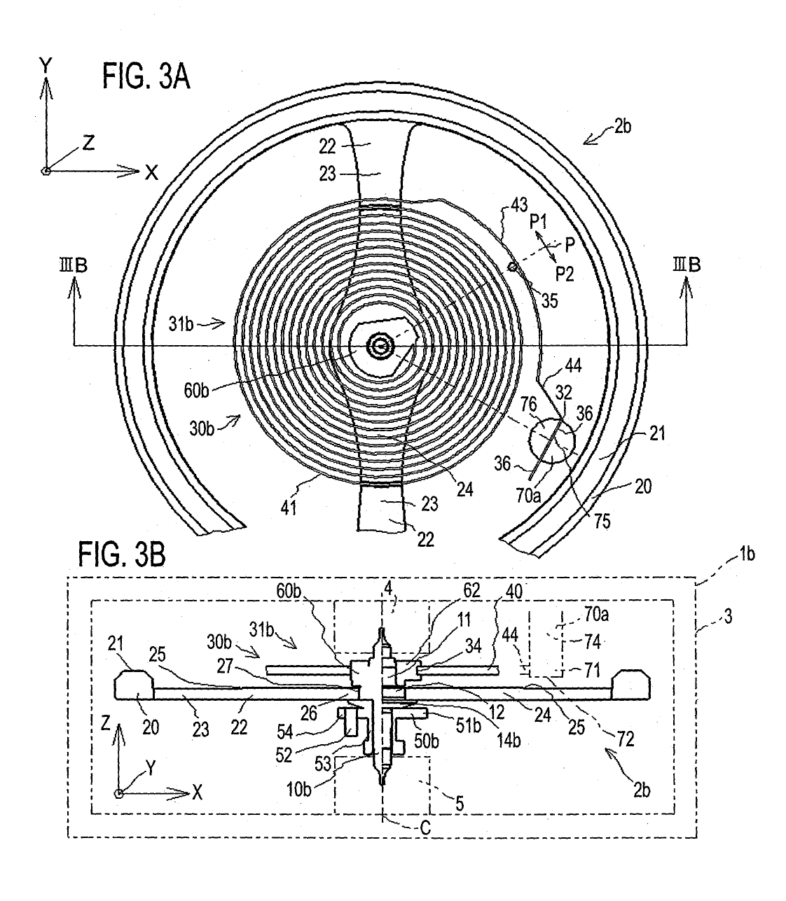

Further, not only the hairspring holder portion 60a is integrally molded with the hairspring main body portion 40 as in the second embodiment but also as shown by a third embodiment shown in FIG. 3, a hairspring structure 30b may be formed by integrally molding a hairspring holder portion 60b and a balance core portion 10b with the hairspring main body portion 40. FIG. 3 shows a movement 1b having a speed control mechanism 2b having the hairspring structure 30b. According to the third embodiment shown in FIG. 3, members, portions or elements substantially the same as members, portions or elements shown in the second embodiment of FIG. 2, are attached with notations the same as those in the case of the second embodiment and members, portions or elements corresponding to but changed from members, portions or elements shown in the second embodiment, are attached with “b” in place of “a” at final positions of notations within a range necessary for explanation.

According to the speed control mechanism 2b of FIG. 3, in order to enable to attachedly mount the balance wheel 20 to the central shaft portion 12 of the balance core portion 10b integrally molded with the hairspring main body portion 40 and the hairspring holder portion 60b, a flange portion or a flange portion 14b for supporting the amida portion 22 of the balance wheel 20, is formed separately from the balance core portion 10b and is integrated to an oscillation seat 50b in this example. The oscillation seat 50b made of brass or the like is fixed to the lower shaft portion 13 of the balance core portion 10b by calking the small flange portion 55 or fixed to the lower side shaft portion 13 of the balance core portion 10b by a setscrew screwed to a horizontal hole of the cylindrical portion 53.

It is apparent that also the speed control mechanism 2b of the movement 1b achieves operation and effect similar to that of the speed control mechanism 2a according to the second embodiment. Further, in this case, the balance core 10b is made of carbon nanofiber and its frictional coefficient is low and therefore, when the balance core 10b is rotatably supported by the bearings 4 and 5, frictional resistance can be restrained to a minimum. Thereby, an oscillation angle of the balance with hairspring is increased and therefore, the duration time period is prolonged and accuracy is also promoted. In this case, in fabricating at least a portion of the balance core portion 10b axially supported by the receiving jewels 4 and 5, the portion may be molded by using small particles of carbon nanofiber having a comparatively small aspect ratio or a comparatively high rate of a resin constituting a binder of carbon nanofiber may be made to remain.

Although according to the above-described, an explanation has been given of an example of molding the hairspring main body portion integrally with the hairspring stud or the hairspring holder, there may be constructed a constitution in which only the hairspring is made of carbon nanofiber separately from the hairspring stud or the hairspring holder and the outer peripheral side and the inner peripheral side front end portions of the hairspring made of carbon nanofiber are respectively fitted into the groove portions of the hairspring stud and the hairspring holder to fix by calking and also in that case, it is apparent from the above-described explanation that various advantages are achieved.

What is claimed is

1. A hairspring structure made of a carbon nanofiber constituted by being molded integrally.

2. A hairspring structure comprising:
a hairspring main body made of a carbon nanofiber; and
a hairspring attaching portion made of a carbon nanofiber which is molded integrally with the main body, coupled to one end portion of the main body and substantially rigid.

3. The hairspring structure according to claim 2, wherein the hairspring attaching portion comprises a hairspring holder portion coupled to an inner peripheral side end portion of the hairspring main body.

4. The hairspring structure according to claim 2, wherein the hairspring attaching portion is constituted to be coupled to an inner peripheral side end portion of the hairspring main body and operate as a hairspring holder and a balance core.

5. The hairspring structure according to claim 2, wherein the hairspring attaching portion comprises a hairspring stud portion coupled to an outer peripheral side end portion of the hairspring main body.

6. A speed control mechanism comprising:
the hairspring according to claim 1; and
a balance wheel connected to the hairspring or the hairspring structure.

7. A speed control mechanism comprising:
the hairspring structure according to claim 2; and
a balance wheel connected to the hairspring or the hairspring structure.

8. A timepiece having the speed control mechanism according to claim 6.

9. A timepiece having the speed control mechanism according to claim 7.
